(19) United States
(12) Patent Application Publication
(10) Pub. No.: US 2025/0225287 A1
(43) Pub. Date: Jul. 10, 2025

(54) SYSTEMS AND METHODS FOR SIMPLIFYING CONVEX HULLS

(71) Applicant: Electronic Arts Inc., Redwood City, CA (US)

(72) Inventor: Ashton Mason, Brighton (GB)

(21) Appl. No.: 18/407,969

(22) Filed: Jan. 9, 2024

(51) Int. Cl. G06F 30/15; G06F 30/23; G06F 113/28

(52) U.S. Cl. CPC G06F 30/15; G06F 30/23; G06F 2113/28

(57) ABSTRACT

A method, device, and computer-readable storage medium for simplifying a convex hull are disclosed. A first queue of candidate vertices of a convex hull for vertex removal is generated, wherein the candidate vertices are sorted in the first queue by ascending values of a first cost metric associated with removal of the candidate vertex. A second queue of candidate faces of the convex hull for face removal is generated, wherein the candidate faces are sorted in the second queue by ascending values of a second cost metric associated with removal of the candidate face. A simplification operation is performed on the convex hull to generate a simplified version of the convex hull by performing a vertex removal operation on the candidate vertex in the first queue with lowest first cost metric or performing a face removal operation on the candidate face in the second queue with lowest second cost metric.

### FIELD

This disclosure generally relates to computer graphics and, more particularly, to systems and methods for simplifying complex hulls.

### BACKGROUND

For three-dimensional (3D) graphics applications, such as video games or animated films, efficient processing of data by reducing computational complexity of a given operation is often useful. This is particularly the case in real-time applications, such as video games.

Various operations can be performed using computer generated objects in a scene. An object may be represented as a polygonal mesh, which comprises a collection of vertices, edges, and faces that define the shape and/or boundary of the object.

One technique to reduce the computational complexity of a given graphics operation involving a 3D object is to use a lower complexity stand-in for the 3D object for the given graphics operation. One common technique, which is often used in physics simulations such as collisions, is to use a lower complexity “convex hull” representing the full resolution 3D object. Performing collision detection directly on full resolution 3D objects as created by artists or generated from images can be computationally costly and prone to error because the volumes of full resolution 3D objects are typically complex and may have concavities that may make it difficult to determine whether a point is inside or outside a volume when performing collision detection. A convex hull of some arbitrary (potentially non-convex) 3D object is the simplest, smallest convex surface that completely contains, or bounds, the 3D object. By using the convex hull of a 3D object for collision detection, the speed and accuracy of computerized collision detection can be substantially increased.

Some computer graphics applications that use convex hulls for physics simulations give artists the ability to reduce the complexity of convex hulls by, for example, limiting a maximum number of vertices of a convex hull. However, when a convex hull is simplified to reduce its vertex count to meet a vertex budget for a simplified convex hull, the results can sometimes be a poor stand-in for the original full resolution 3D object. This may result in artifacts in collision detection or other physics operations involving the simplified convex hulls.

Accordingly, there remains a need in the art for an improved system and method for simplifying convex hulls.

### SUMMARY

Embodiments of the disclosure provide a method, device, and computer-readable storage medium for simplifying a convex hull. The method includes: receiving a convex hull of a polygonal mesh representing a three-dimensional (3D) object; receiving an instruction to generate a simplified version of the convex hull; generating a first queue of candidate vertices of the convex hull for vertex removal, wherein the candidate vertices of the convex hull for vertex removal are sorted in the first queue based on ascending values of a first cost metric associated with removing the candidate vertex by a vertex removal operation; generating a second queue of candidate faces of the convex hull for face removal, wherein the candidate faces of the convex hull for face removal are sorted in the second queue based on ascending values of a second cost metric associated with removing the candidate face by a face removal operation; and performing a simplification operation on the convex hull based on the first queue and the second queue to generate the simplified version of the convex hull, wherein the simplification operation comprises a vertex removal operation on the candidate vertex in the first queue with lowest first cost metric or a face removal operation on the candidate face in the second queue with lowest second cost metric.

### BRIEF DESCRIPTION OF THE DRAWINGS

FIG. 1 is a block diagram of a computer system for rendering images, according to aspects of the present disclosure.

FIG. 2 is a block diagram illustrating processor and buffer interaction, according to one embodiment.

FIG. 3 is a block diagram of a scene to be rendered, according to one embodiment.

FIG. 4A is a block diagram illustrating rendering of a scene, according to one embodiment.

FIG. 4B is an example of an image of a scene, according to one embodiment.

FIG. 5 is an example of a polygonal mesh of a 3D object, according to one embodiment.

FIG. 6A is an example of a convex hull of the polygonal mesh shown in FIG. 5, in one embodiment

FIG. 6B shows an example of a convex decomposition of the convex hull in FIG. 6A, according to one embodiment

FIGS. 7A-7E illustrate vertex removal, in one embodiment.

FIGS. 8A-8B illustrate vertex removal, in one embodiment.

FIGS. 9A-9C illustrate face removal, in one embodiment.

FIGS. 10A-10B illustrate face removal, in one embodiment.

FIGS. 11A-11C illustrate face removal, in one embodiment.

FIGS. 12A-12B illustrate vertex removal and face removal, in one embodiment.

FIG. 13 is a flow diagram of method steps for simplifying a convex hull, according to one embodiment.

### DETAILED DESCRIPTION

The following detailed description is exemplary in nature and is not intended to limit the disclosure or the application and uses of the disclosure. Furthermore, there is no intention to be bound by any expressed or implied theory presented in the preceding technical field, background, summary, brief description of the drawings, or the following detailed description.

Embodiments of the disclosure provide a system and method for simplifying convex hulls. Some disclosed embodiments iteratively mix two different mesh simplification operators to simplify a convex hull, where one operation makes the convex hull smaller and the other operator makes the convex hull larger, in an effort to avoid the gradual shrinking of the simplified hull. In one implementation, one operator removes a single vertex from the convex hull, and the other operator removes a single face from the convex hull. Of these operators, vertex removal necessarily reduces the vertex count of the convex hull by one, so this operator consistently makes progress in simplifying a convex hull. Removing a face sometimes reintroduces vertices in the short term, but also increases the volume of the convex hull. Because vertex removal and face removal are in a sense opposites, some embodiments consider other factors when considering a face removal operation, so as not to become stuck in an infinite loop. An infinite loop could be formed when a face is removed, introducing a new vertex, then that same vertex is removed, re-introducing the original face, and so on.

As used herein, vertex valence of a vertex is a number of faces incident on the vertex, and a total vertex valence for a convex hull is the sum of the vertex valences of the vertices of the convex hull. In some embodiments, each vertex removal operation decreases the total vertex valence of a convex hull. As such, any vertex removal operation would reduce the total vertex valence of the convex hull. In some embodiments, face removal operations are considered candidates for simplifying the convex hull if the face removal operation reduces the total vertex valence of the convex hull (or keeps the total vertex valence the same). In some embodiments, any face removal operation that increases the total vertex valence of the convex hull is discarded and not a candidate for face removal.

Embodiments of the disclosure also provide for a unified cost metric associated with both vertex removal and face removal operations and chooses from among both operators in making convex hull simplification decisions. By iteratively mixing between vertex removal operations and face removal operations, embodiments of the disclosure provide a system and method for reducing the complexity (e.g., vertex count) of a convex hull, while maintaining a more robust representation of the original 3D object for which the convex hull is used as a stand-in for graphics operations such as collision detection.

Taking the context of video games as an example, the display of a video game is generally a video sequence presented to a display device capable of displaying the video sequence. The video sequence typically comprises a plurality of frames. By showing frames in succession in sequence order, simulated objects appear to move. A game engine typically generates frames in real-time response to user input, so rendering time is often constrained.

As used herein, a “frame” refers to an image of the video sequence. In some systems, such as interleaved displays, the frame might comprise multiple fields or more complex constructs, but generally a frame can be thought of as a view into a computer-generated scene at a particular time or short time window. For example, with 60 frames-per-second video, if one frame represents the scene at t=0 seconds, then the next frame would represent the scene at t= 1/60 seconds. In some cases, a frame might represent the scene from t-0 seconds to t= 1/60 seconds, but in the simple case, the frame is a snapshot in time.

A “scene” comprises those simulated objects that are positioned in a world coordinate space within a view pyramid, view rectangular prism, or other shaped view space. In some approaches, the scene comprises all objects (that are not obscured by other objects) within a view pyramid defined by a view point and a view rectangle with boundaries being the perspective planes through the view point and each edge of the view rectangle, possibly truncated by a background.

The simulated objects can be generated entirely from mathematical models describing the shape of the objects (such as arms and a torso described by a set of plane and/or curve surfaces), generated from stored images (such as the face of a famous person), or a combination thereof. If a game engine (or more specifically, a rendering engine that is part of the game engine or used by the game engine) has data as to where each object or portion of an object is in a scene, the frame for that scene can be rendered using standard rendering techniques.

A scene may comprise several objects or entities with some of the objects or entities being animated, in that the objects or entities may appear to move either in response to game engine rules or user input. For example, in a basketball game, a character for one of the basketball players might shoot a basket in response to user input, while a defending player will attempt to block the shooter in response to logic that is part of the game rules (e.g., an artificial intelligence component of the game rules might include a rule that defenders block shots when a shot attempt is detected) and when the ball moves through the net, the net will move in response to the ball. The net is expected to be inanimate, but the players' movements are expected to be animated and natural-appearing. Animated objects are typically referred to herein generically as characters and, in specific examples, such as animation of a football, soccer, baseball, basketball, or other sports game, the characters are typically simulated players in the game. In many cases, the characters correspond to actual sports figures and those actual sports figures might have contributed motion capture data for use in animating their corresponding character. Players and characters might be nonhuman, simulated robots, or other character types.

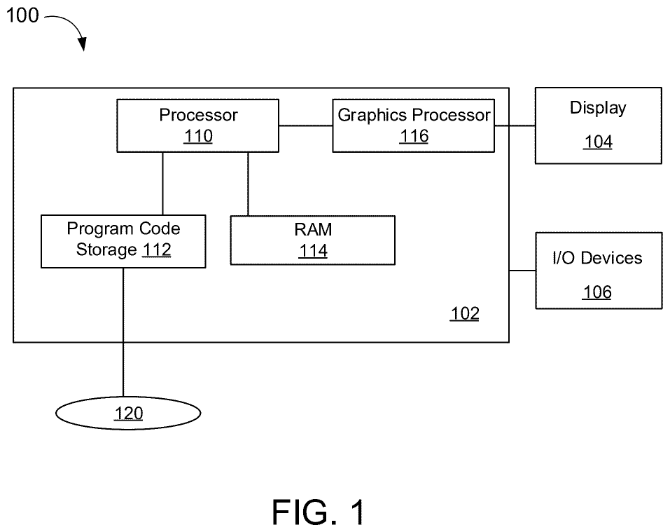

Turning to the drawings, FIG. 1 is a block diagram of a computer system 100 for rendering images, according to aspects of the present disclosure. The computer system 100 may be, for example, used for rendering images of a video game. The computer system 100 is shown comprising a console 102 coupled to a display 104 and input/output (I/O) devices 106. Console 102 is shown comprising a processor 110, program code storage 112, temporary data storage 114, and a graphics processor 116. Console 102 may be a handheld video game device, a video game console (e.g., special purpose computing device) for operating video games, a general-purpose laptop or desktop computer, or other suitable computing system, such as a mobile phone or tablet computer. Although shown as one processor in FIG. 1, processor 110 may include one or more processors having one or more processing cores. Similarly, although shown as one processor in FIG. 1, graphics processor 116 may include one or more processors having one or more processing cores.

Program code storage 112 may be ROM (read only-memory), RAM (random access memory), DRAM (dynamic random access memory), SRAM (static random access memory), hard disk, other magnetic storage, optical storage, other storage or a combination or variation of these storage device types. In some embodiments, a portion of the program code is stored in ROM that is programmable (e.g., ROM, PROM (programmable read-only memory), EPROM (erasable programmable read-only memory), EEPROM (electrically erasable programmable read-only memory), etc.) and a portion of the program code is stored on removable media such as a disc 120 (e.g., CD-ROM, DVD-ROM, etc.), or may be stored on a cartridge, memory chip, or the like, or obtained over a network or other electronic channel as needed. In some implementations, program code can be found embodied in a non-transitory computer-readable storage medium.

Temporary data storage 114 is usable to store variables and other game and processor data. In some embodiments, temporary data storage 114 is RAM and stores data that is generated during play of a video game, and portions thereof may also be reserved for frame buffers, depth buffers, polygon lists, texture storage, and/or other data needed or usable for rendering images as part of a video game presentation.

In one embodiment, I/O devices 106 are devices a user interacts with to play a video game or otherwise interact with console 102. I/O devices 106 may include any device for interacting with console 102, including but not limited to a video game controller, joystick, keyboard, mouse, keypad, VR (virtual reality) headset or device, etc.

Display 104 can any type of display device, including a television, computer monitor, laptop screen, mobile device screen, tablet screen, etc. In some embodiments, I/O devices 106 and display 104 comprise a common device, e.g., a touchscreen device. Still further, in some embodiments, one or more of the I/O devices 106 and display 104 is integrated in the console 102.

In various embodiments, since a video game is likely to be such that the particular image sequence presented on the display 104 depends on results of game instruction processing, and those game instructions likely depend, in turn, on user inputs, the console 102 (and the processor 110 and graphics processor 116) are configured to quickly process inputs and render a responsive image sequence in real-time or near real-time.

Various other components may be included in console 102, but are omitted for clarity. An example includes a networking device configured to connect the console 102 to a network, such as the Internet.

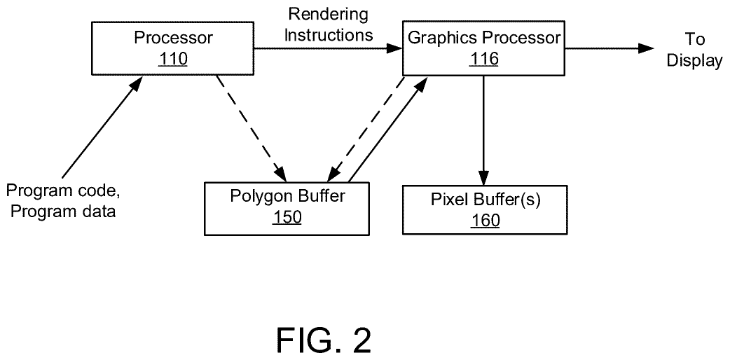

FIG. 2 is a block diagram illustrating processor and buffer interaction, according to one embodiment. As shown in FIG. 2, processor 110 executes program code and program data. In response to executing the program code, processor 110 outputs rendering instructions to graphics processor 116. Graphics processor 116, in turn, reads data from a polygon buffer 150 and interacts with pixel buffer(s) 160 to form an image sequence of one or more images that are output to a display. Alternatively, instead of sending rendering instructions to graphics processor 116 or in addition to sending rendering instructions to graphics processor 116, processor 110 may directly interact with polygon buffer 150. For example, processor 110 could determine which objects are to appear in a view and provide polygon or other mathematical representations of those objects to polygon buffer 150 for subsequent processing by graphics processor 116.

In one example implementation, processor 110 issues high-level graphics commands to graphics processor 116. In some implementations, such high-level graphics commands might be those specified by the OpenGL specification, or those specified by a graphics processor manufacturer.

In one implementation of an image rendering process, graphics processor 116 reads polygon data from polygon buffer 150 for a polygon, processes that polygon and updates pixel buffer(s) 160 accordingly, then moves on to the next polygon until all the polygons are processed, or at least all of the polygons needing to be processed and/or in view are processed. As such, a renderer processes a stream of polygons, even though the polygons may be read in place and be a finite set, where the number of polygons is known or determinable. For memory efficiency and speed, it may be preferable in some implementations that polygons be processed as a stream (as opposed to random access, or other ordering), so that fast, expensive memory used for polygons being processed is not required for all polygons comprising an image.

In some embodiments, processor 110 may load polygon buffer 150 with polygon data in a sort order (if one is possible, which might not be the case where there are overlapping polygons), but more typically polygons are stored in polygon buffer 150 in an unsorted order. It should be understood that although these examples use polygons as the image elements being processed, the apparatus and methods described herein can also be used on image elements other than polygons.

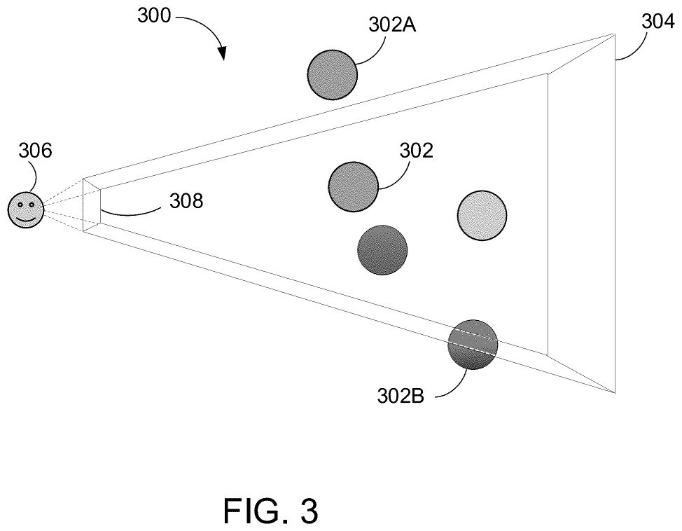

FIG. 3 is a block diagram of a scene 300 to be rendered, according to one embodiment. The scene 300 includes a plurality of 3D (three-dimensional) objects, including objects 302, 302A, 302B, for example. Each object can be comprised of a set of polygons, e.g., triangles. A camera 306 is configured to capture an image of the scene 300. A projection of the scene 300 is captured by the camera 306 and is represented by screen space 308. The view of the scene 300 captured by the camera 306 is represented by viewport 304. As shown, some of the objects, such as object 302A of the scene 300, may be outside the viewport 304. As also shown, some of the objects, such as object 302B, may be partially outside the viewport 304.

In one embodiment, the image of the scene 300 that is displayed on a display device corresponds to the screen space 308. The view of the scene 300 that the camera 306 can see (i.e., the image represented by screen space 308) can change as the camera 306 moves in 3D space relative to the objects in the scene. Also, the objects can move in the scene 300.

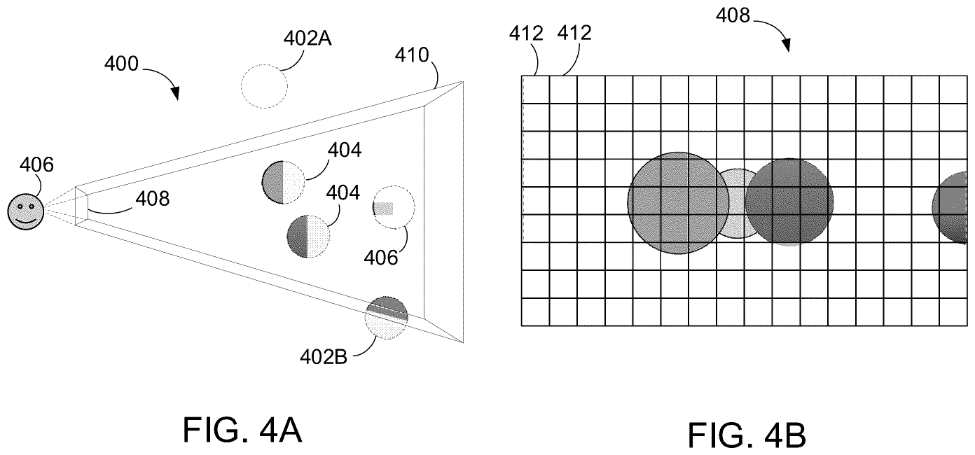

FIG. 4A is a block diagram illustrating rendering of a scene 400, according to one embodiment. Similar to the diagram shown in FIG. 3, scene 400 includes a plurality of objects. A camera 406 is configured to capture an image of the scene 400, represented in screen space 408. The camera 406 observes the scene 400 through viewport 410.

Various techniques can be used to render the scene 400 in screen space, including rasterization, ray tracing, or other techniques. Rasterization strives to render the pixels as those that are directly visible from the camera 406. In some implementations, rasterization can provide good performance when the renderer (e.g., processor 110 and/or graphics processor 116) does not need any global information about the scene 400.

One rasterization algorithm takes the 3D scene 400, which is described as objects comprising polygons, and renders the scene onto a 2D surface, usually a computer monitor, in screen space 408. The polygons are themselves represented as collections of triangles. Each triangle is represented by three vertices in 3D space. At a very basic level, rasterizers take a stream of vertices, transform them into corresponding 2D points in screen space 408, and fill in the transformed 2D triangles as appropriate.

Rasterization typically involves culling one or more objects or partial objects. Frustum culling removes any objects outside the viewport 410, such as object 402A. Viewport culling removes portions of objects that are partially overlapping the edge of the viewport 410, such as a portion of object 402B. Backface culling removes a back portion 404 of objects that cannot be seen by the camera 406. In some embodiments, depth testing can be performed to remove, on a per pixel basis in screen space 408, portions 406 of objects that are occluded by other objects.

When rasterization is complete, an image of scene in screen space 408 is generated. In some embodiments, pixel density of the screen space 408 can also result in information loss about the objects in the scene 400.

FIG. 4B is an example of an image of a scene, according to one embodiment. The image shown in FIG. 4B represents the image in screen space 408 of the scene 400 captured by the camera 406 in FIG. 4A.

For each pixel 412 in screen space 408, the processor has access to data corresponding to the position of the object within the pixel, the color of the object, the object's orientation, properties of the object (e.g., transparency or translucency), and/or surface roughness information, etc. The result of rasterization is, therefore, a 2D image of the 3D scene.

Although rendering has been described herein using rasterization, other embodiments may involve rendering a scene using other techniques, such as ray tracing, ray casting, radiosity, or any other rendering technique or combination thereof.

### Convex Hulls

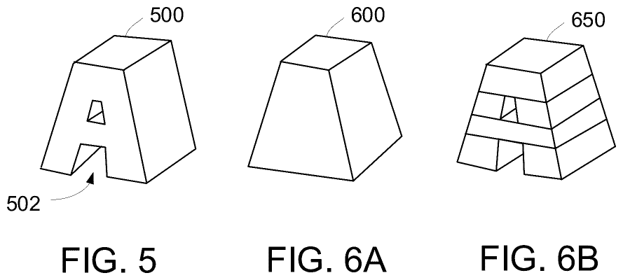

As discussed in greater detail herein, embodiments of the disclosure provide a system and method for simplifying convex hulls. In some implementations, a convex hull of some arbitrary (potentially non-convex) mesh of a 3D object is a smallest convex set of surfaces that completely contains, or bounds, the mesh of the 3D object. FIG. 5 is an example of a polygonal mesh 500 of a 3D object, according to one embodiment. The polygonal mesh 500 in FIG. 5 is a non-convex mesh in that it includes at least one concave portion 502.

FIG. 6A is an example of a convex hull 600 of the polygonal mesh 500 shown in FIG. 5, in one embodiment. Various algorithms can be used for generating the convex hull 600 of an input polygonal mesh. In one embodiment, a convex hull can be created manually by an artist. In another embodiment, a convex hull can be computed based on an input polygonal mesh. For example, one algorithm for computing a convex hull of an input polygonal mesh is the “quick hull” algorithm. The quick hull algorithm uses a divide-and-conquer strategy to compute the convex hull of a shape. A shape's convex hull (also referred to as the convex closure) is the smallest set of points encapsulating the shape. In one implementation of the quick hull algorithm in two dimensions, the following steps are performed to find the convex hull.
1. Find the points with minimum and maximum x coordinates, as these will necessarily be part of the convex hull. If many points with the same minimum/maximum x exist, use the ones with the minimum/maximum y, respectively.
2. Use the line formed by the two points to divide the set into two subsets of points, which will be processed recursively. The next steps describe how to determine the part of the hull above the line. The part of the hull below the line can be determined similarly.
3. Determine the point above the line with the maximum distance from the line. This point forms a triangle with the two points on the line.
4. The points lying inside of that triangle cannot be part of the convex hull and can therefore be ignored in the next steps.
5. Recursively repeat the previous two steps on the two lines formed by the two new sides of the triangle.
6. Continue until no more points are left, the recursion has come to an end and the points selected constitute the convex hull.

Determining the convex hull in three dimensions is more complex, as the convex hull is built from many facets. A data structure should account for that and record the line/plane/hyperplane (ridge) shared by neighboring facets. For d dimensions:
1. Pick d+1 points from the set that do not share a plane or a hyperplane. This forms an initial hull with facets Fs[ ].
2. For each F in Fs[ ], find all unassigned points that are “above” it; i.e., pointing away from the center of the hull, and assign them to an “outside” set F.O associated with F. The algorithm maintains the invariant that every point that has not been added to the hull but could potentially be a vertex of it is assigned to exactly one outside set.
3. For each F with a non-empty F.O:
   a. Find the point p in F.O with the maximum distance from F and add it to the hull. Note that p will not necessarily be a vertex of the final hull, as it might be removed later.
   b. Create a visible set V and initialize it to F. Extend V in all directions for neighboring facets Fv until no further facets are visible from p. Fv being visible from p means that p is above Fv.
   c. The boundary of V then forms the set of horizon ridges H.
   d. Let Fnew[ ] be the set of facets created from p and all ridges in H.
   e. Unassign all points in the outside sets of facets in V. For each new facet in Fnew[ ], perform step (2) only considering these newly unassigned points to initialize its outside set. Note that every point that remains unassigned at the end of this process lies within the current hull.
   f. Delete the now-internal facets in V from Fs[ ]. Add the new facets in Fnew[ ] to Fs[ ] and continue the iteration.

Convex hulls are commonly used in computer games to reduce the complexity of certain graphics operations. Convex hulls are commonly used as part of collision detection and physics systems, where they serve as convex approximations of other meshes. The collision system exploits the convexity of the convex hull to simplify collision calculations that otherwise would be expensive, essentially turning them into convex optimization problems. Collision detection with a convex approximation of a 3D object is often a good approximation of full-blown collision detection with the 3D object itself, as long as the colliding object (e.g., the player or a projectile) is not too small or too closely observed by the player.

Because in-game collision need not be perfectly accurate to still be convincing, it is common to use approximate convex hulls that omit some detail of the original mesh. Whereas an accurately generated convex hull mesh will contain a vertex for every point of the input mesh that lies on its mathematical convex hull (and no other vertices), in practice video games can get away with far simpler hulls that either do not contain a vertex for every hull point (so do not completely bound the input mesh) or else contain vertices that lie outside the convex hull (so bound extra space not inside the convex hull).

In some implementations, artist-facing tools may include features for automatic generation of convex hulls fitted to arbitrary meshes (or parts of meshes selected by an artist). Sliders allow the artist to limit the vertex count of the generated convex hull, for example to a threshold vertex budget according to how that model is collided with in-game.

In some implementations, the artist-facing tools may also have more sophisticated features that generate collections of convex hulls fitted to complex meshes using what is known as a convex decomposition. FIG. 6B shows an example of a convex decomposition 650 of the convex hull 600 in FIG. 6A, according to one embodiment. In the convex decomposition 650, the convex hull 600 is divided into multiple separate convex hulls. By automatically fitting multiple convex hulls to a 3D model, convex decomposition decomposes the overall shape of the 3D model into multiple convex hull pieces. In some implementations, convex decomposition saves an artist the trouble of hand-fitting convex hulls to parts of models that are too complex or too large to be well-approximated by a single convex hull. Since all the generated pieces of the convex decomposition 650 are themselves convex hulls, together the convex decomposition 650 forms a valid compound collision shape. In some implementations, configurable sliders allow artists to limit the complexity (e.g., vertex count) of both the overall the convex decomposition 650 and the individual convex hulls.

In order to implement convex hulls with configurable complexity, a method for automatic simplification of convex hulls is needed.

One immediate way to simplify convex hulls is simply to generate them again, leaving out some of the input points. These embodiments could, for example, pick a vertex on the convex hull that contributes least to its shape, identify the corresponding vertex on the input mesh, remove that vertex from the input mesh, and generate a new convex hull from the reduced input mesh. While this approach would result in a simplified convex hull, this approach is quite expensive since in general the convex hull generation process is run many times, once for each successively simplified convex hull.

For this reason, embodiments of the disclosure provide systems and methods that iteratively simplify a convex hull in-place by simplification operations without regenerating an entirely new convex hull. As described in greater detail herein, the simplification operations may include vertex removal and face removal operations.

### Vertex Removal

In one embodiment, given a previously generated convex hull, one way to simplify the convex hull is to remove one of its vertices and edit the surrounding faces in an operation referred to herein as vertex removal. When a vertex is removed from a convex hull, the faces immediately incident to the vertex in the convex hull are removed as well. Removal of the faces leaves an open boundary that is then filled by new faces created to patch the open boundary.

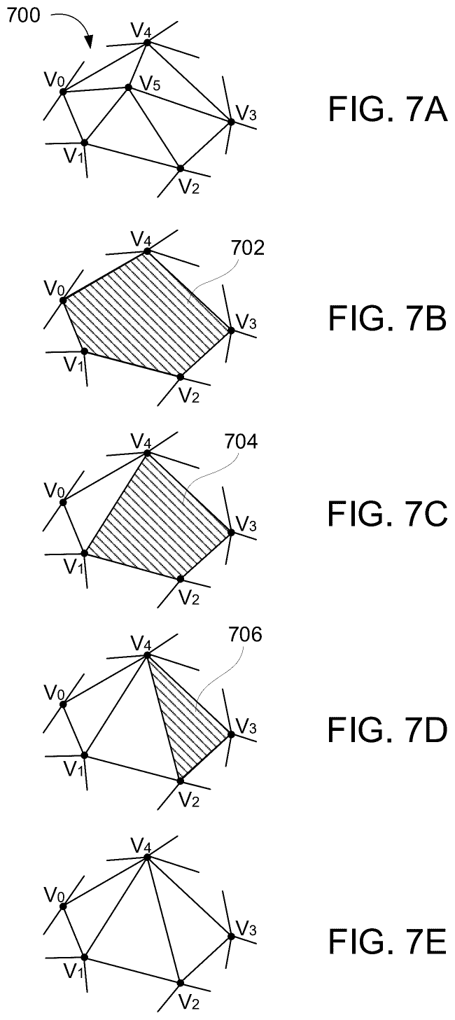

FIG. 7A is an example of a portion of convex hull 700, in one embodiment. The portion of the convex hull 700 shown includes vertices v₀, v₁, v₂, v₃, v₄, v₅. Suppose that vertex v₅ is a candidate for vertex removal.

FIG. 7B illustrates the portion of convex hull 700 with vertex v₅ removed, in one embodiment. The faces incident to vertex v₅ are also removed, leaving an open boundary 702. The open boundary 702 is then triangulated, as shown in FIGS. 7C-7E.

Given a candidate vertex on the convex hull for vertex removal (such as vertex v₅), embodiments of the disclosure build a data structure describing its removal. This data structure includes a list of all the faces incident to the candidate vertex, which would also need to be removed. In FIG. 7A, for vertex v₅, the incident faces are triangles (v₀, v₁, v₅), (v₁, v₂, v₅), (v₂, v₃, v₅), (v₃, v₄, v₅), and (v₄, v₀, v₅).

In one implementation, the data structure also includes a circular list of vertices forming the boundary of this patch of incident faces, which would become an open boundary after the faces incident to the candidate vertex are removed, and so would need to be filled with new triangles. FIG. 7B shows this open boundary (v₀, v₁, v₂, v₃, v₄).

In one implementation, the data structure also includes a list of faces (shown as triangles in the example in FIGS. 7A-7E, each described by a triple of three vertices) that would be created to fill the boundary. FIG. 7C shows created triangle (v₀, v₁, v₄) leaving an updated open boundary 704, FIG. 7D shows created triangle (v₁, v₂, v₄) leaving an updated open boundary 706, and FIG. 7E shows created triangle (v₂, v₃, v₄) that completes closure of the open boundary resulting from removing vertex v₅.

In some implementations, extraction of the patch of faces incident to the candidate vertex for removal and the boundary of the patch of faces can be directly computed. To generate the new triangles to tessellate the boundary, one embodiment triangulates a non-planar polygon while ensuring that the new triangles keep the convex hull convex. The triangulation adds one triangle at a time, maintaining a representation of the remaining open boundary at each stage, until the open boundary is filled and the remaining open boundary becomes empty. One implementation adds triangles incident to two successive edges of the boundary, and does not create triangles that span from an edge on one side of the boundary to a non-adjacent vertex on the other.

In one embodiment, in each step of re-triangulation, a triangle to add from the multiple possible candidate triangles is selected. The selected triangle is added to a list of planned triangles and its edges are removed from the remaining boundary. Each available candidate triangle is considered in turn, selecting the first triangle that is found to keep the convex hull convex. A candidate triangle keeps the convex hull convex if all remaining vertices of the boundary lie within (or below) its plane. For example, FIG. 7C shows the creation of one possible triangle (v₀, v₁, v₄), leaving remaining boundary (v₁, v₂, v₃, v₄). Vertices v₂ and v₃ should both lie within the plane of created triangle (v₀, v₁, v₄) (note, vertices v₀, v₁ and v₄ lie within the plane of the created triangle by definition). Creation of subsequent triangles (v₁, v₂, v₄) and (v₂, v₃, v₄) is shown in FIG. 7D and FIG. 7E, respectively. The creation of the last triangle (v₂, v₃, v₄) in FIG. 7E removes all three remaining edges from the open boundary, leaving it empty, and the triangulation terminates.

Degenerate candidate triangles, for which no single valid plane can be calculated, are not selected as candidates for re-triangulation. If all available candidates are degenerate, some embodiments resort to selecting a triangle at random.

In pathological cases, such as where the convex hull has been simplified very aggressively, the removal of a vertex may “pinch” the convex hull so that edges on opposite sides of the convex hull would be merged, making the convex hull non-manifold, where non-manifold geometry refers to a mesh where any edge is shared by more than two faces. Such illegal collapses may be detected and rejected.

Once the data structure describing the removal of a vertex has been created, the vertex removal operation can be executed by removing the patch of faces indicated for removal, adding the new triangles indicated for generation, and removing the vertex itself, which is left unreferenced.

### Convex Hull Simplification Algorithm

Given the vertex removal operator described above, some embodiments can implement a simple iterative mesh simplification scheme that removes one vertex at a time until a maximum vertex budget is satisfied. At its simplest, such a scheme might re-examine every remaining vertex of the convex hull at each step, and select the vertex whose removal has least negative impact on the accuracy of the convex hull.

In one embodiment, a cost metric that estimates the negative impact of removing a given vertex on the convex hull is the maximum height of the given vertex above the planes of the triangles that would replace the given vertex if the given vertex was removed. By evaluating this cost metric for each available vertex, some embodiments select the candidate vertex with lowest cost for removal at each step.

In order to avoid repeatedly re-evaluating every vertex, some embodiments can store the candidate vertices still available for removal in a priority queue ordered by ascending cost, and select the vertex at the front of the queue (i.e., with the lowest cost metric) at each step. As candidate vertices are removed from the queue and then removed from the convex hull, some embodiments arrange to recompute the costs of their neighbor vertices, whose local geometry may have been altered by the vertex removal, and thus update the queue.

While removal of successive vertices from a relatively complex convex hull does serve to simplify the convex hull, vertex removal also tends to shrink the convex hull, reducing its volume. Each removed vertex lies outside the simplified convex hull that remains after removal of the vertex.

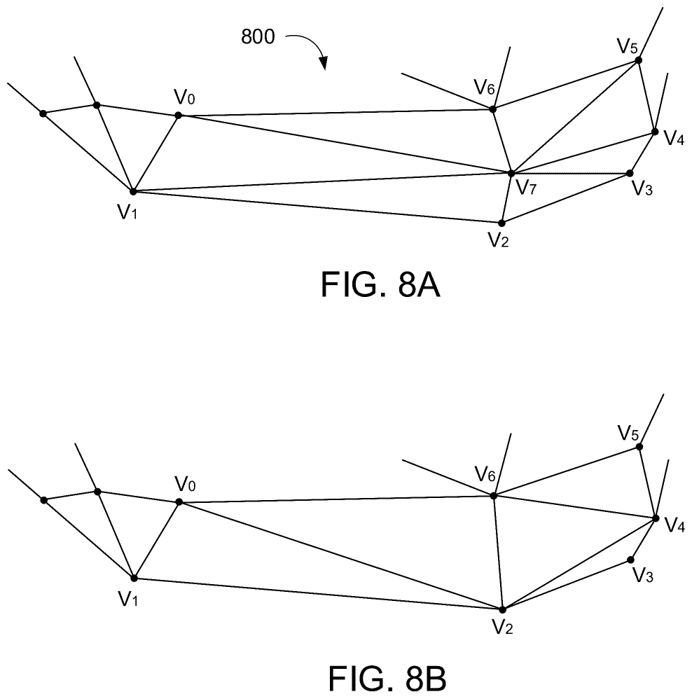

FIG. 8A is an example of a portion of a convex hull 800, in one embodiment. The portion of the convex hull 800 shown includes vertices v₀, v₁, v₂, v₃, v₄, v₅, v₆, v₇. Suppose that vertex v₇ is a candidate for vertex removal.

In FIG. 8B, vertex v₇ is removed from the convex hull 800 shown in FIG. 8A. Vertex v₇ is replaced by new triangles (v₀, v₁, v₂), (v₂, v₆, v₀), (v₆, v₂, v₄), (v₄, v₂, v₃), and (v₄, v₅, v₆) in

FIG. 8B. Because vertex v₇ lay outside the simplified convex hull created in FIG. 8B, the effect of the removal of vertex v₇ is to decrease the volume of the convex hull 800 shown in FIG. 8A. Used to excess, the simplified convex hull can become significantly smaller than the original.

In an implementation involving a convex decomposition made up of serval convex hulls (such as shown in FIG. 6B), when neighboring convex hulls of a convex decomposition are shrunk (e.g., by vertex removal simplifying each separate convex hull), gaps can appear between the neighboring convex hulls, making the convex decomposition no longer a complete representation of the original 3D model. This can result in physics errors in-game, where a player or projectile is able to overlap parts of the 3D model no longer covered by the convex hulls of the convex decomposition.

### Face Removal

In order to reduce the shrinkage of convex hulls caused by application of successive vertex removal operations, embodiments of the disclosure introduce a second hull simplification operator (i.e., face removal) that increases convex hull volume, rather than reducing it. The face removal operator is, in a sense, the opposite of vertex removal. Where vertex removal removes a single vertex and creates one or more faces in its place, face removal removes a single face and creates one or more new vertices in its place.

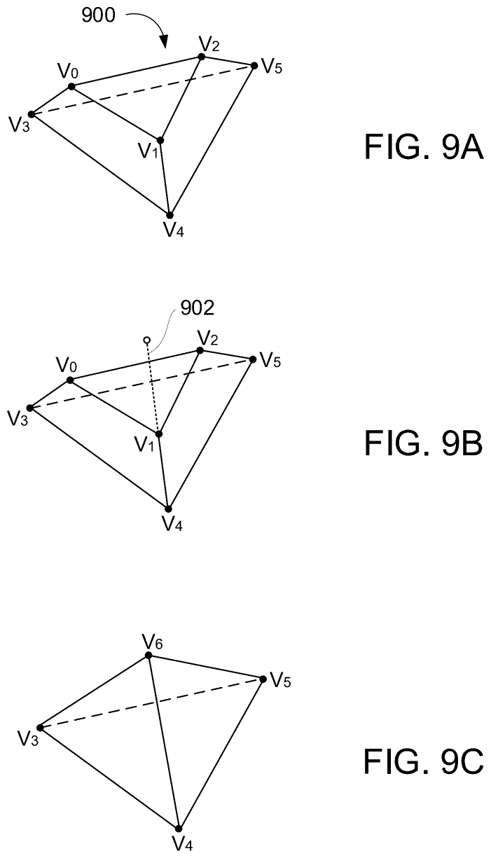

FIGS. 9A-9C illustrate face removal, in one embodiment. In FIG. 9A, convex hull 900 is shown, including vertices v₀, v₁, v₂, v₃, v₄, v₅. Suppose face (v₀, v₁, v₂) is removed from the convex hull 900.

When face (v₀, v₁, v₂) is removed, the faces that are its neighbors (i.e., faces that share an edge with face (v₀, v₁, v₂)) are extended upward. In FIG. 9A, the faces that are the neighbors of face (v₀, v₁, v₂) are the side faces (v₀, v₃, v₄, v₁), (v₁, v₄, v₅, v₂), and (v₂, v₅, v₃, v₀).

In one embodiment, one or more new vertices are created at the points where those extended side faces intersect. One implementation notionally creates up to one new vertex for each existing vertex of the removed face. However, in some cases, multiple vertices of the removed face may be mapped to the same new vertex. In FIG. 9C, all existing vertices v₀, v₁ and v₂ from FIG. 9A are mapped to the same new vertex v₆. A vertex valence as used herein is the number of faces incident on a vertex. Where a vertex of the removed face has a vertex valence of three (i.e., three incident faces, including the removed face plus two others), the vertex is removed and the third incident edge at the vertex (not in the removed face) is extended upward, as shown for vertex v₁ in FIG. 9B. A new vertex is created at the point of the first intersection of the extended edge 902 with one of the planes of the other neighbor faces (not incident to the vertex). Vertex v₆ is created at the intersection point of the line extended up through edge (v₄, v₁) with the plane of the only other neighbor face (v₂, v₅, v₃, v₀), as shown in FIGS. 9B-9C.

In the example shown, similar intersection calculations for lines extended upward from the third edges of the other vertices v₀ and v₂ of the removed face intersect the planes of other neighbor faces at the same point (i.e., at vertex v₆). For that reason, some embodiments create only a single new vertex v₀ at that point, and associate it with each of the existing vertices v₀, v₁, and v₂.

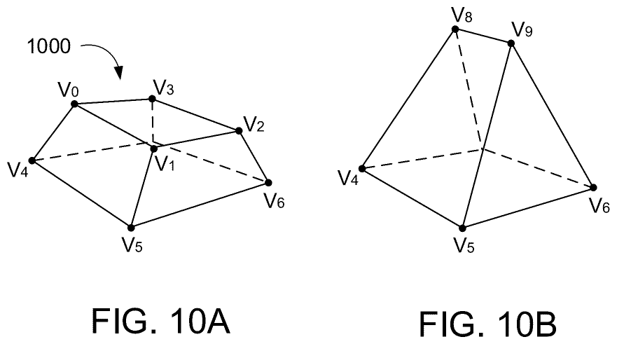

In some cases, some extended edges may intersect faces at different points, leading to the creation of more than one new vertex when a face is removed. FIGS. 10A-10B illustrate face removal, in one embodiment. In FIG. 10A, convex hull 1000 is shown, including vertices v₀, v₁, v₂, v₃, v₄, v₅, v₆. Suppose face (v₀, v₁, v₂, v₃) is to be removed from the convex hull 1000.

Removal of the face (v₀, v₁, v₂, v₃) in FIG. 10A leads to the creation of two new vertices v₅ and v₉ at the two unique intersection points where the edges extended upward through each of v₀, v₁, v₂ and v₃ first intersect the planes of neighbor faces not incident to those edges, as shown in FIG. 10B.

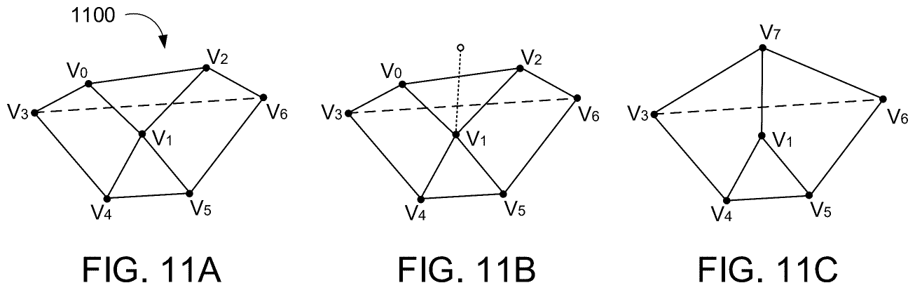

In some implementations of embodiments of the face removal operator disclosed herein, where an existing vertex of the removed face has valence greater than three, the vertex is retained. In this case, a new edge extends upward to a new vertex. This edge is the intersection of the pair of neighbor faces incident to the vertex. FIGS. 11A-11C also illustrate face removal, in one embodiment. In FIG. 11A, convex hull 1100 is shown, including vertices v₀, v₁, v₂, v₃, v₄, v₅, v₆. Suppose face (v₀, v₁, v₂) is to be removed from the convex hull 1100.

Vertices v₀ and v₂ in FIG. 11A have vertex valence of three and so are removed, as shown in FIG. 11C, replaced instead by new vertex v₇ created where their edges intersect the planes of other neighbor faces. Vertex v₁, by contrast, has four incident faces and hence vertex valence of four. In this case, no single edge incident to vertex v₁ can be extended upward. Instead, a new edge is created, as shown in FIG. 11B, along the line of intersection of the two neighbor faces (v₁, v₀, v₃, v₄) and (v₁, v₅, v₆, v₂) incident to v₁. Some embodiments find the point where that new edge line first intersects one of the other neighbor faces, as usual, and create a new vertex there. In this example, that intersection point is the same as for the other extended edges, and vertex v₇ suffices for all.

Given a convex hull face that is a candidate for face removal, embodiments of the disclosure build a data structure describing its removal. The data structure includes a list of points at which new vertices will be created when a face is removed. The data structure also includes a map identifying, for each vertex of the removed face, which new vertex, at one of those points, it will be mapped to.

To build the list of points and the map, embodiments of the disclosure consider each existing vertex of the removed face in turn. A ray is extended upward (out of the removed face) along the line where the planes of the two neighbor faces incident to the vertex intersect. The intersection points of this ray with each of the planes of the other neighbor faces (not incident to the vertex) are calculated, and whichever intersection point is nearest is selected. Next, we check whether we have already identified the creation of a new vertex at that found intersection point. We check the list of points already identified as locations for new vertices, and if one of them is identical (for example, to within a tolerance threshold distance) then we map the vertex to the same point. Otherwise, if none of the previously identified points is a match, we add the newly calculated point to the list and map the existing vertex to that point.

Although some embodiments may find a topological argument for identifying existing points as matches for the new point, one implantation involves a simple geometric test, classifying two intersection points as identical if their calculated values are within a tolerance threshold distance.

In principle, all the intersections of extended rays with planes of other neighbor faces must lie outside the convex hull, in the positive directions of the rays, because the convex hull is convex. In degenerate cases where individual faces have zero area or where pairs of hull faces are parallel or nearly parallel, the calculation can break down and the intersection point may be either not well-defined or not significantly outside the current convex hull. Some embodiments reject the removal of the face as degenerate if the normal of any involved face is not well-defined, if any extended ray is not well-defined, if the intersection point of any extended ray with a neighbor face is not well-defined, or if the line parameter of any intersection point (i.e., its distance along the ray from the existing vertex) is not significantly positive within a threshold.

Once the data structure describing the removal of a face has been created, the face removal operation can be executed by creating a new vertex at each of the points in the list, deleting the existing face and all of its neighbor faces (which share an edge with it), and then adding new faces to replace the deleted faces. In FIG. 11C, we create the single new vertex v₇, delete the existing face (v₀, v₁, v₂) and its neighbor faces (v₁, v₅, v₆, v₂), (v₂, v₆, v₃, v₀), and (v₁, v₀, v₃, v₄), and finally add new faces (v₁, v₅, v₆, v₇), (v₆, v₃, v₇), and (v₃, v₄, v₁, v₇).

Note that some embodiments build up descriptions of the new faces to be added before deleting the existing faces, while they are still available for inspection. Some embodiments could elect to store the descriptions of the new faces in the data structure describing the removal of the face, as is done for vertex removals.

In some implementations, the new “face” that replaces the removed face may be degenerate, consisting of less than three unique vertices. For generality, some embodiments still build its description, and then discard it if it is degenerate. All vertices of the removed face are replaced in general by new vertices created at intersection points. We build up a description of the new face by visiting each of the vertices of the removed face in turn, adding the new vertex to which it is mapped to a list of the vertices describing the new face. In general, the vertex mapping may be many-to-one, with multiple vertices of the removed face mapped to the same new vertex. Where this occurs, some embodiments assume that vertices mapped to the same new vertex will be successive in the original face; if they are not, then the mapping is incorrect and for safety the removal is rejected. When adding new vertices to which vertices are mapped to the list of vertices, some embodiments discard any vertices that are identical to the last vertex added. To ensure that all successive duplicates are detected, some embodiments select a start vertex that is not mapped to the same new vertex as the vertex before it. In the case where all vertices are mapped to the same new vertex, we can pick any start vertex.

Building the descriptions of the faces that replace the neighbor faces is different, in one implementation. For a removed face, each neighbor face shares exactly one edge and two vertices with the removed face. Only those vertices are mapped to newly created vertices, and the others can all be added to the list directly. In some implementations, the two vertices that are mapped to new vertices may still be included themselves, depending on their valence. It is noted that vertices with valence of three disappear and are effectively replaced by the new vertices to which they are mapped, while vertices with valence higher than three are retained. Some embodiments start by adding the first vertex of the shared edge (in winding order), if its valence is greater than three. Then we add the new vertex to which that vertex is mapped. Next we add the new vertex to which the second vertex of the shared edge is mapped—but only if it is not the same new vertex. Finally, we add the second vertex of the shared edge, if its valence is greater than three. The other vertices of the neighbor face can then be simply appended in winding order.

Referring to FIG. 11A, consider the description of the new face that replaces neighbor face (v₁, v₅, v₆, v₂). We start by considering, but not adding v₂, since its valence is three. Then we add the vertex v₇ to which v₂ is mapped. Next we consider the vertex v₇ to which v₁ is mapped, but decline to add it since it is a repeat. Then we add v₁, since its valence is greater than three. Finally we add the other vertices of the neighbor face in winding order, namely v₅ and v₆. The resultant description is (v₇, v₁, v₅, v₆).

When adding the new faces that replace the deleted faces, some embodiments use the previously built descriptions that define them. If the deleted neighbor faces can be assumed to be planar, then the faces that replace them will be planar also and can simply be added directly. The face that replaces the removed face, if any, may in general not be planar. For simplicity, some embodiments triangulate the face, using a triangulation chosen to keep the convex hull convex. Note again that the face that replaces the removed face can be degenerate, with fewer than three vertices. If so, it is discarded. As with vertex removals, some embodiments also detect and reject candidate face removals that would pinch the mesh, making it non-manifold, where non-manifold geometry refers to a mesh where any edge is shared by more than two faces.

### Convex Hull Simplification Algorithm Using Vertex Removal and Face Removal

To avoid excessive shrinkage of simplified hulls, some embodiments of the disclosure mix vertex removal and face removal operations on the same convex hull. In one implementation, two separate priority queues are maintained (one of available candidate vertex removals and one of available candidate face removals), both ordered by a common cost metric. In another implementation, a single priority queue holds candidates for both vertex removal and face removal. Candidates for vertex removals and face removals are ordered by ascending cost.

In one embodiment, the cost of a face removal is estimated as the maximum height of any of the newly created vertices above the plane of the removed face. In another embodiment, the cost of a face removal is the maximum height above any of the planes of the triangles that replace the removed face.

At each simplification step, embodiments of the disclosure select a removal operation from the front of either the vertex removal queue or face removal queue (or a common queue). The disclosed embodiments select the removal with lowest cost among the candidate vertex removals and the candidate face removals. Upon execution of the selected removal operation, both queues are updated to remove any candidates that no longer exist, and the cost estimates of any candidates whose costs may have changed are also updated.

When a vertex is removed, some embodiments destroy the candidates for the deleted faces incident to the vertex, create new candidates for the faces that replace them, and update the costs of the candidates for the boundary vertices, whose surrounding faces have changed.

When a face is removed, some embodiments destroy the existing candidates for the neighboring faces, and create new candidates for the faces that replace them and for any triangles that replace the removed face (if any). We also destroy the candidates for the vertices of the removed face, create candidates for the newly created vertices, and create new candidates for any vertices of the removed face that still remain after removal.

In some implementations, mixing vertex removals and face removals in the same iterative simplification loop helps to reduce the gradual shrinkage of the convex hull caused by vertex removal alone. While vertex removal always removes a single vertex from the mesh, face removal does not always reduce the vertex count, depending on the topology of the convex hull mesh around the removal. Nevertheless, since face removal reduces the number of faces in the convex hull, successive operations do tend to eventually simplify the mesh.

It should be noted that the simplification algorithm disclosed herein can become stuck in an infinite loop where a vertex is repeatedly removed by a vertex removal and then re-created by a face removal, and so on.

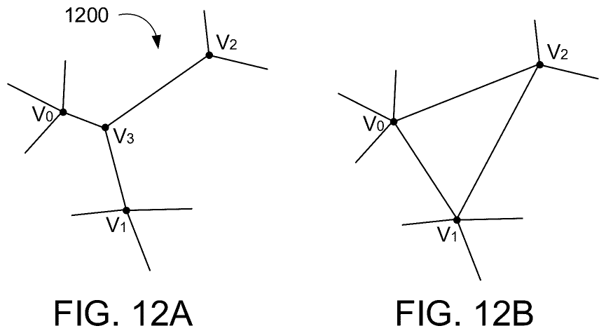

FIG. 12A shows a portion of convex hull 1200, in one embodiment. The convex hull 1200 includes vertices v₀, v₁, v₂, v₃. Suppose vertex v₃ in FIG. 12A is removed, and replaced with the single face (v₀, v₁, v₂), as shown in FIG. 12B. A subsequent removal of face (v₀, v₁, v₂) reintroduces a new vertex at the same location as vertex v₃. This could cause an infinite loop.

In that regard, some face removal operations are less desirable because, in some sense, they just undo the work of a prior vertex removal. Thus, embodiments of the disclosure provide a mechanism to avoid such problematic face removals. Although face removal operations do not always remove vertices, they do in cases where the vertices of the removed face have vertex valence of exactly three. The removal of each such vertex reduces the total vertex valence of the convex hull (i.e., the sum of the valences of all vertices) by three.

As such, embodiments of the disclosure use vertex valance as a metric by which desirable face removals can be distinguished from undesirable ones that contradict vertex removals. Some embodiments can ensure that removal operations (vertex removal or face removal) always make progress by disallowing operations that increase the total vertex valence of the convex hull. Operations that would increase the total valence are rejected and not enqueued as candidates. Optionally, some embodiments can also reject removals that leave the total vertex valence unchanged.

The effect of a removal operation on the total vertex valence can be predicted in some embodiments by inspection of the data structures that are built describing candidate removal operations, summing the number of faces incident to each vertex prior to, and after, the operation.

When a vertex is removed, the total vertex valence is decreased by the valence of the removed vertex itself. Additionally, the valences of the vertices in the patch boundary are often reduced. The exact reduction at each boundary vertex depends on the triangulation of the boundary. Only the faces of the patch are replaced, i.e., with the triangles of the planned triangulation. Therefore, the valence contribution of the other faces is unchanged, and can be ignored. Thus, some embodiments start by deducting all references to the boundary vertices by the faces in the removed patch, then add all new references to the boundary vertices by the triangles of the triangulation.

When a face is removed, the valence is reduced by one at each vertex of the collapsed face with valence greater than three. Vertices with vertex valence of exactly three are removed, effectively reducing the total valence by three at those vertices. Each newly created vertex has a vertex valence equal to the number of faces that reference the vertex after the face removal. The faces that can reference the new vertex include any faces that replace the removed face (if it does not degenerate away), plus the face that replaces each of the neighbor faces. Some embodiments start by counting a single reference (to one of the created vertices) for each vertex of each face or triangle created to replace the removed face, if the removed face does not degenerate away. Since the removed face after remapping can reference only the new vertices, and can only reference each new vertex once, we know the removed face degenerates away if the number of new vertices is less than three. Then, we count references to the new vertices in each of the remapped neighbor faces. Each neighbor face can reference each newly created vertex at most once after the removal.

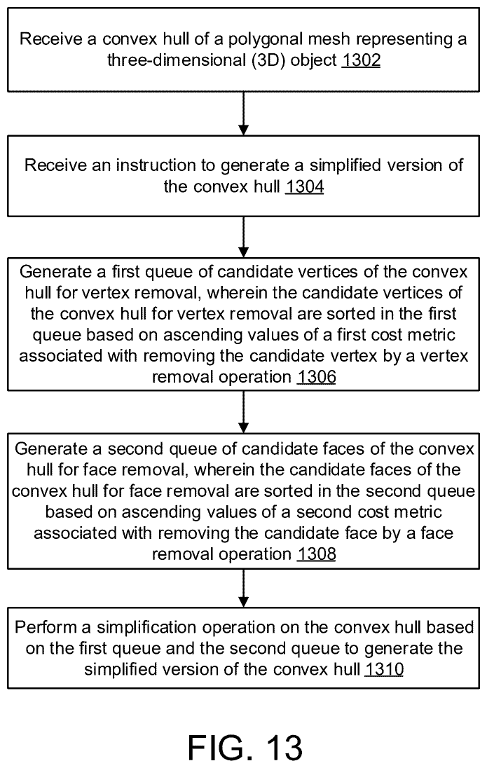

FIG. 13 is a flow diagram of method steps for simplifying a convex hull, according to one embodiment. In various implementations, the method can be performed by the processor 110, the graphics processor 116, or a combination of the processor 110 and the graphics processor 116. In some embodiments, two or more steps shown in FIG. 13 may be performed by the same process or at the same time or in a different order.

As shown, the method begins at step 1302, where the processor receives a convex hull of a polygonal mesh representing a three-dimensional (3D) object. The polygonal mesh may be an artist-authored mesh. The convex hull of the polygonal mesh representing the 3D object comprises a smallest convex set of surfaces that completely bounds the polygonal mesh of the 3D object. In one embodiment, the convex hull is created manually by an artist. In another embodiment, the convex hull is created by a convex hull generating algorithm, such as for example quick hull.

At step 1304, the processor receives an instruction to generate a simplified version of the convex hull. In one embodiment, the instruction to generate the simplified version of the convex hull may be received from an artist that uses a graphical interface tool, such as a slider, to provide a maximum vertex budget for the convex hull. In some implementations involving a convex hull that is a convex decomposition comprised of separate convex hull pieces, the instruction may provide a maximum vertex budget for the entire convex decomposition and/or a maximum vertex budget for each separate convex hull piece.

At step 1306, the processor generates a first queue of candidate vertices of the convex hull for vertex removal, wherein the candidate vertices of the convex hull for vertex removal are sorted in the first queue based on ascending values of a first cost metric associated with removing the candidate vertex by a vertex removal operation. In one embodiment, the first cost metric for a given candidate vertex for vertex removal is a maximum height of the given candidate vertex above planes of faces (e.g., triangles) that replace the given candidate vertex when the given candidate vertex is removed by a vertex removal operation.

At step 1308, the processor generates a second queue of candidate faces of the convex hull for face removal, wherein the candidate faces of the convex hull for face removal are sorted in the second queue based on ascending values of a second cost metric associated with removing the candidate face by a face removal operation. In one embodiment, the second cost metric for a given candidate face for face removal is a maximum height of any newly created vertices above a plane of the given candidate face when the given candidate face is removed by a face removal operation. In another embodiment, the second cost metric for a given candidate face for face removal is a maximum height above any plane of newly created faces (e.g., triangles) that replace the given candidate face when the given candidate face is removed by a face removal operation.

In some embodiments, a given face of the convex hull is included as a candidate face for face removal based on removal of the face resulting in a decrease in a total vertex valence of the convex hull. A vertex valance for a vertex is count of a number of faces incident on the vertex, and the total vertex valence of the convex hull is a sum of the vertex valences of the vertices of the convex hull. Any faces whose removal would result in increasing the total vertex valence are not considered as candidate faces and are not included in the second queue. Some embodiments also discard as possible candidates any faces whose removal would result in the total vertex valence being unchanged.

At step 1310, the processor performs a simplification operation on the convex hull based on the first queue and the second queue to generate the simplified version of the convex hull. In one embodiment, the simplification operation comprises a vertex removal operation on the candidate vertex in the first queue with lowest first cost metric or a face removal operation on the candidate face in the second queue with lowest second cost metric. In one embodiment, the simplification operation comprises the vertex removal operation on the candidate vertex in the first queue with lowest first cost metric based on the candidate vertex in the first queue with lowest first cost metric having a lower value than the candidate face in the second queue with lowest second cost metric. In one embodiment, the simplification operation comprises the face removal operation on the candidate face in the second queue with lowest second cost metric based on the candidate face in the second queue with lowest second cost metric having a lower value than the candidate vertex in the first queue with lowest first cost metric.

In some implementations, the candidate vertices for vertex removal and the candidate faces for face removal are stored in two separate queues. In some implementations, the candidate vertices for vertex removal and the candidate faces for face removal are stored in a common queue sorted by lowest first cost metric (for candidate vertices) and second cost metric (for candidate faces), i.e., the common queue comprises the first queue and the second queue.

After performing the simplification operations, first cost metrics for candidate vertices in the first queue and second cost metrics for the candidate faces in the second queue are updated based on the updated topology of the simplified version of the convex hull.

In some embodiments, the instruction to generate the simplified version of the convex hull includes a maximum vertex count for the simplified version of the convex hull. The method comprises iteratively performing the simplification operation to remove candidate vertices or candidate faces (i.e., the next lowest cost candidate) until the simplified version of the convex hull satisfies the maximum vertex count.

As disclosed herein, embodiments of the disclosure provide a system and method for simplifying convex hulls that mixes two different operators to avoid excessive shrinking (or expansion) of convex hulls caused by using just one operator exclusively. The first operator is vertex removal. The second operator is face removal. The two operators are in some sense opposite: one replaces a vertex with faces and decreases convex hull volume, the other replaces a face with vertices and increases convex hull volume.

Some disclosed embodiments present an improved algorithm that also uses a metric based on vertex valence to distinguish desirable face removal candidates from undesirable face removal candidates. Desirable face removal candidates are those that decrease (or keep unchanged, in some embodiments) the total vertex valence of the convex hull.

Disclosed also is a unified cost metric that estimates the negative impact on convex hull fidelity of a removal operation (whether it be a vertex removal operation or face removal operation) based on measuring the maximum distances of vertices from the planes of the faces that replace them. This unified cost metric can be implemented consistently for both removal operators (vertex removal or face removal), allowing them to be meaningfully ordered by a common priority cost metric.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A method for simplifying a convex hull, the method comprising:
receiving a convex hull of a polygonal mesh representing a three-dimensional (3D) object;
receiving an instruction to generate a simplified version of the convex hull;
generating a first queue of candidate vertices of the convex hull for vertex removal, wherein the candidate vertices of the convex hull for vertex removal are sorted in the first queue based on ascending values of a first cost metric associated with removing the candidate vertex by a vertex removal operation;
generating a second queue of candidate faces of the convex hull for face removal, wherein the candidate faces of the convex hull for face removal are sorted in the second queue based on ascending values of a second cost metric associated with removing the candidate face by a face removal operation; and
performing a simplification operation on the convex hull based on the first queue and the second queue to generate the simplified version of the convex hull, wherein the simplification operation comprises a vertex removal operation on the candidate vertex in the first queue with lowest first cost metric or a face removal operation on the candidate face in the second queue with lowest second cost metric.

2. The method according to claim 1,
wherein the simplification operation comprises the vertex removal operation on the candidate vertex in the first queue with lowest first cost metric based on the candidate vertex in the first queue with lowest first cost metric having a lower value than the candidate face in the second queue with lowest second cost metric; and
wherein the simplification operation comprises the face removal operation on the candidate face in the second queue with lowest second cost metric based on the candidate face in the second queue with lowest second cost metric having a lower value than the candidate vertex in the first queue with lowest first cost metric

3. The method according to claim 1, wherein the candidate vertices in the first queue and the candidate faces in the second queue are stored in a common queue based on lowest values of the first cost metrics for the candidate vertices and the second cost metrics for the candidate faces.

4. The method according to claim 1, wherein the convex hull of the polygonal mesh representing the 3D object comprises a smallest convex set of surfaces that completely bounds the polygonal mesh of the 3D object.

5. The method according to claim 1, wherein the instruction to generate the simplified version of the convex hull includes a maximum vertex count for the simplified version of the convex hull, wherein the method comprises iteratively performing the simplification operation to remove candidate vertices or candidate faces until the simplified version of the convex hull satisfies the maximum vertex count.

6. The method according to claim 1, wherein the convex hull is a convex decomposition comprised of separate convex hull pieces, and wherein the simplification operation is performed on each of the separate convex hull pieces of the convex decomposition.

7. The method according to claim 1, wherein the first cost metric for a given candidate vertex for vertex removal comprises a maximum height of the given candidate vertex above planes of faces that replace the given candidate vertex when the given candidate vertex is removed by a vertex removal operation.

8. The method according to claim 1, wherein the second cost metric for a given candidate face for face removal comprises:
a maximum height of any newly created vertices above a plane of the given candidate face when the given candidate face is removed by a face removal operation; or
a maximum height above any plane of newly created faces that replace the given candidate face when the given candidate face is removed by a face removal operation.

9. The method of claim 1, wherein a given face of the convex hull is included as a candidate face for face removal in the second queue based on removal of the given face resulting in the simplified convex hull having a total vertex valence that is less than a total vertex valence of the convex hull prior to removal of the given face, wherein a vertex valance for a given vertex in a given convex hull is count of a number of faces incident on the given vertex, and a total vertex valence of the given convex hull is a sum of the vertex valences of the vertices of the given convex hull.

10. A non-transitory computer-readable storage medium storing instructions that, when executed by one or more processors, causes a computing device to simplify a convex hull, by performing the steps of:
receiving a convex hull of a polygonal mesh representing a three-dimensional (3D) object;
receiving an instruction to generate a simplified version of the convex hull;
generating a first queue of candidate vertices of the convex hull for vertex removal, wherein the candidate vertices of the convex hull for vertex removal are sorted in the first queue based on ascending values of a first cost metric associated with removing the candidate vertex by a vertex removal operation;
generating a second queue of candidate faces of the convex hull for face removal, wherein the candidate faces of the convex hull for face removal are sorted in the second queue based on ascending values of a second cost metric associated with removing the candidate face by a face removal operation; and
performing a simplification operation on the convex hull based on the first queue and the second queue to generate the simplified version of the convex hull, wherein the simplification operation comprises a vertex removal operation on the candidate vertex in the first queue with lowest first cost metric or a face removal operation on the candidate face in the second queue with lowest second cost metric.

11. The computer-readable storage medium according to claim 10,
wherein the simplification operation comprises the vertex removal operation on the candidate vertex in the first queue with lowest first cost metric based on the candidate vertex in the first queue with lowest first cost metric having a lower value than the candidate face in the second queue with lowest second cost metric; and
wherein the simplification operation comprises the face removal operation on the candidate face in the second queue with lowest second cost metric based on the candidate face in the second queue with lowest second cost metric having a lower value than the candidate vertex in the first queue with lowest first cost metric

12. The computer-readable storage medium according to claim 10, wherein the candidate vertices in the first queue and the candidate faces in the second queue are stored in a common queue based on lowest values of the first cost metrics for the candidate vertices and the second cost metrics for the candidate faces.

13. The computer-readable storage medium according to claim 10, wherein the convex hull of the polygonal mesh representing the 3D object comprises a smallest convex set of surfaces that completely bounds the polygonal mesh of the 3D object.

14. The computer-readable storage medium according to claim 10, wherein the instruction to generate the simplified version of the convex hull includes a maximum vertex count for the simplified version of the convex hull, wherein the simplification operation is iteratively performed to remove candidate vertices or candidate faces until the simplified version of the convex hull satisfies the maximum vertex count.

15. The computer-readable storage medium according to claim 10,
wherein the first cost metric for a given candidate vertex for vertex removal comprises a maximum height of the given candidate vertex above planes of faces that replace the given candidate vertex when the given candidate vertex is removed by a vertex removal operation; and
wherein the second cost metric for a given candidate face for face removal comprises:
a maximum height of any newly created vertices above a plane of the given candidate face when the given candidate face is removed by a face removal operation; or
a maximum height above any plane of newly created faces that replace the given candidate face when the given candidate face is removed by a face removal operation.

16. The computer-readable storage medium according to claim 10, wherein a given face of the convex hull is included as a candidate face for face removal in the second queue based on removal of the given face resulting in the simplified convex hull having a total vertex valence that is less than a total vertex valence of the convex hull prior to removal of the given face, wherein a vertex valance for a given vertex in a given convex hull is count of a number of faces incident on the given vertex, and a total vertex valence of the given convex hull is a sum of the vertex valences of the vertices of the given convex hull.

17. A device for simplifying a convex hull, the device comprising:
a memory storing instructions; and
one or more processors configured to the execute the instructions to cause the device to:
receive a convex hull of a polygonal mesh representing a three-dimensional (3D) object;
receive an instruction to generate a simplified version of the convex hull;
generate a first queue of candidate vertices of the convex hull for vertex removal, wherein the candidate vertices of the convex hull for vertex removal are sorted in the first queue based on ascending values of a first cost metric associated with removing the candidate vertex by a vertex removal operation;
generate a second queue of candidate faces of the convex hull for face removal, wherein the candidate faces of the convex hull for face removal are sorted in the second queue based on ascending values of a second cost metric associated with removing the candidate face by a face removal operation; and
perform a simplification operation on the convex hull based on the first queue and the second queue to generate the simplified version of the convex hull, wherein the simplification operation comprises a vertex removal operation on the candidate vertex in the first queue with lowest first cost metric or a face removal operation on the candidate face in the second queue with lowest second cost metric.

18. The device according to claim 17,
wherein the simplification operation comprises the vertex removal operation on the candidate vertex in the first queue with lowest first cost metric based on the candidate vertex in the first queue with lowest first cost metric having a lower value than the candidate face in the second queue with lowest second cost metric; and
wherein the simplification operation comprises the face removal operation on the candidate face in the second queue with lowest second cost metric based on the candidate face in the second queue with lowest second cost metric having a lower value than the candidate vertex in the first queue with lowest first cost metric

19. The device according to claim 17,
wherein the first cost metric for a given candidate vertex for vertex removal comprises a maximum height of the given candidate vertex above planes of faces that replace the given candidate vertex when the given candidate vertex is removed by a vertex removal operation; and
wherein the second cost metric for a given candidate face for face removal comprises:
a maximum height of any newly created vertices above a plane of the given candidate face when the given candidate face is removed by a face removal operation; or
a maximum height above any plane of newly created faces that replace the given candidate face when the given candidate face is removed by a face removal operation.

20. The device according to claim 17, wherein a given face of the convex hull is included as a candidate face for face removal in the second queue based on removal of the given face resulting in the simplified convex hull having a total vertex valence that is less than a total vertex valence of the convex hull prior to removal of the given face, wherein a vertex valance for a given vertex in a given convex hull is count of a number of faces incident on the given vertex, and a total vertex valence of the given convex hull is a sum of the vertex valences of the vertices of the given convex hull.
